(19) United States
(12) Patent Application Publication
(10) Pub. No.: US 2012/0115123 A1
(43) Pub. Date: May 10, 2012

(54) PROVIDING LEARNING TOOLS

(76) Inventors: Dana Alan Koch, St. Charles, IL (US); Daniel Bielenberg, Geneva, IL (US); Jason Howard Peterson, Frankfurt am Main (DE); Candice Afia Smith, North Hollywood, CA (US); Daniel C. Wilkens, Winfield, IL (US)

(21) Appl. No.: 13/222,089

(22) Filed: Aug. 31, 2011

Related U.S. Application Data
(60) Provisional application No. 61/411,769, filed on Nov. 9, 2010.

(51) Int. Cl. G09B 3/00

(52) U.S. Cl. 434/351

(57) ABSTRACT

In general, techniques are disclosed for providing an electronic learning tool configured to teach content associated with one or more subject areas. A request for a provisioning of the electronic learning tool is received from a sponsor. A request for a generation of the content is communicated to an entity having access to knowledge of the one or more subject areas. The content is received from the entity. The content is provided to a tool generation entity for generation of the electronic learning tool. The electronic learning tool is received from the tool generation entity. The electronic learning tool is provided to one or more users associated with the sponsor.

### CROSS REFERENCE TO RELATED APPLICATIONS

This patent application claims the benefit of priority of U.S. Provisional Patent Application No. 61/411,769, filed Nov. 9, 2010. The content of U.S. Provisional Patent Application No. 61/411,769 is hereby incorporated by reference into this application as if set forth herein in full.

### TECHNICAL FIELD

This specification relates to providing learning tools and, in one particular implementation, providing learning tools to one or more users in response to a request from a sponsor.

### BACKGROUND

There are many options for providing education to a group of interested users. For example, users can enroll in classes offered by colleges and trade schools, or can utilize products that are directed toward educating users about a particular topic (e.g., self help books, instructions manuals, and the like). In some cases, these avenues of education do not adequately cover a subject area or topic that the users desire to learn or are required to learn.

### SUMMARY

In general, one innovative aspect of the subject matter described in this specification may be embodied in methods for providing an electronic learning tool configured to teach content associated with one or more subject areas. A request for a provisioning of the electronic learning tool is received from a sponsor. A request for a generation of the content is communicated to an entity having access to knowledge of the one or more subject areas. The content is received from the entity. The content is provided to a tool generation entity for generation of the electronic learning tool. The electronic learning tool is received from the tool generation entity. The electronic learning tool is provided to one or more users associated with the sponsor.

Aspects can include one or more of the following features. The content includes both audio and visual content. The audio content includes a voice recording that is associated with the visual content. Receiving the electronic learning tool from the tool generation entity includes receiving audio content that is synchronized with a display of one or more portions of the visual content. Providing the content to the tool generation entity includes storing the content in a database, and providing the tool generation entity with access to the database. In response to receiving the request for a generation of the electronic learning tool from the sponsor, it is determined whether one or more pre-existing electronic learning tools satisfy the request. The electronic learning tool includes an electronic course that is configured to be presented on a user device. The electronic learning tool is configured to receive input from the one or more users. The electronic learning tool is configured to evaluate the input to assess the one or more users' knowledge of the content. The electronic learning tool is configured to evaluate the input to determine the one or more users' opinion of an effectiveness of the electronic learning tool. Receiving the content from the entity includes receiving at least a portion of the content as a completed template. One or more constraints for generating the content is provided to the entity.

Other embodiments of these aspects include corresponding systems, apparatus, and computer programs, configured to perform the actions of the methods, encoded on computer storage devices.

These and other embodiments may each optionally include one or more of the following features.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a diagram of an exemplary system for providing learning tools.

FIG. 2 is a flow chart of an exemplary process for providing learning tools.

FIG. 3 is a diagram of an exemplary work flow related to providing learning tools.

FIG. 4 is a diagram of an exemplary learning tool screen shot.

FIG. 5 is a diagram of an exemplary computing system.

Like reference symbols in the various drawings indicate like elements.

### DETAILED DESCRIPTION

In general, learning tools (e.g., electronic learning tools) can educate users about content from one or more subject areas. In some examples, businesses can provide electronic learning tools to their employees so that the employees can learn useful information at a low cost to the businesses. The present disclosure presents an centralized entity (a “learning tool administration entity”) that enables sponsors to specify requirements for the provisioning of a learning tool, where content for the learning tool is generated by entities that possess (or have access to) the content and a separate entity (a “learning tool generation entity) uses the generated content to generate a functional learning tool. The learning tool administration entity can be made accessible to sponsors, knowledge entities, learning tool generation entities, and users in order to streamline the creation and use of the electronic learning tools. Furthermore, by compartmentalizing tasks related to the provisioning of learning tools, the administration entity can limit the costs and speed the generation of learning tools.

Electronic learning tools are available in a variety of forms, such as audio recordings, video courses, software presentations (e.g., slide shows), exam software, and the like. Electronic learning tools can be desirable over traditional learning tools (e.g., traditional classroom learning with a live instructor) for a number of reasons. For example, a sponsor (e.g., a business) may desire to train a group of users who are located in a location that is not conducive to traditional learning (e.g., users who are working in locations that are far away from traditional learning centers or a group of users who are scattered across multiple locations). Electronic learning materials are also useful because their content can be easily altered or updated as a subject area's landscape evolves. For example, electronic learning tools that relate to a software program can be altered as new versions of the software program are released that contain new features. In some examples, sponsors can distribute existing electronic learning tools (e.g., electronic learning tools that the sponsor already has access to) to a new group of users, thereby avoiding the additional costs that might be associated with enrolling the new group of users in a traditional learning environment, such as an off-site training program.

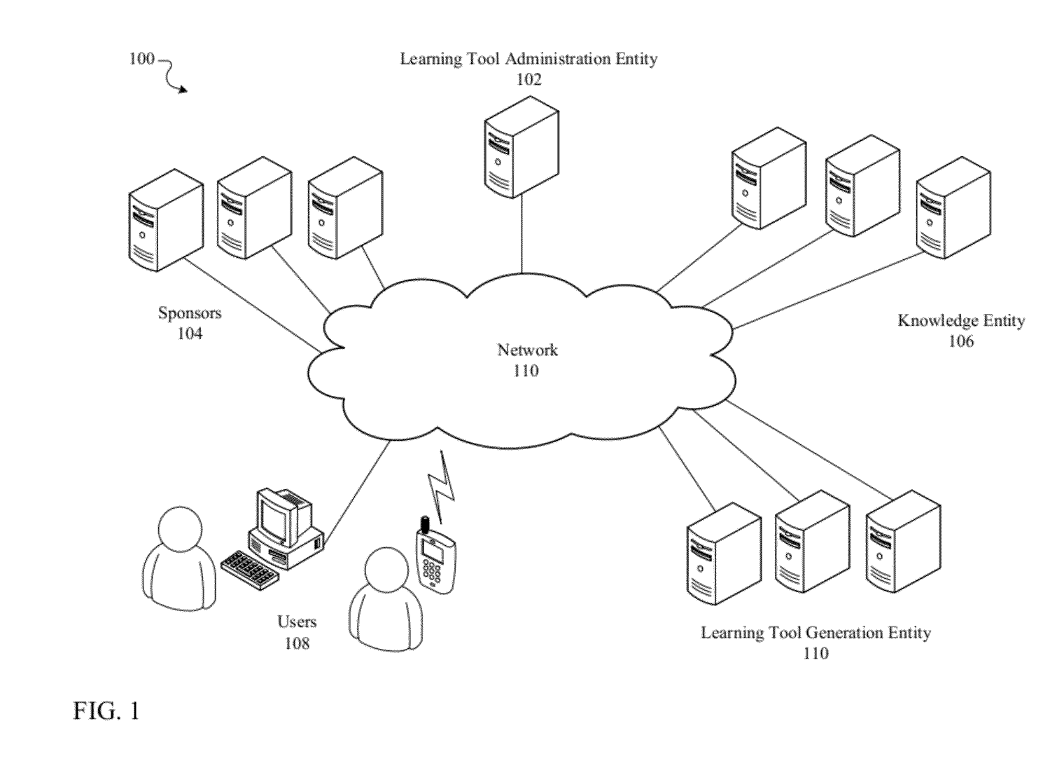

FIG. 1 shows a computing environment 100 that includes a learning tool administration entity 102, sponsors 104, a knowledge entity 106, users 108, and a learning tool generation entity 110. The various entities in the computing environment 100 communicate via a network 110 (e.g., the Internet, a LAN, direct local connections or a combination thereof). In some examples, the sponsors 104 are businesses that are associated with the users 108, who may be employees of the sponsor 104.

In general, the computing environment 100 (and the techniques implemented therein) enables the sponsors 104 to provision electronic learning tools for the users 108. The learning tool administration entity is configured to accept requests from the sponsors 104 for one or more electronic learning tools, procure electronic learning tools that satisfy the request, and provide the electronic learning tools to the sponsors (who can in turn provide the electronic learning tools to the users 108) or to the users 108 directly.

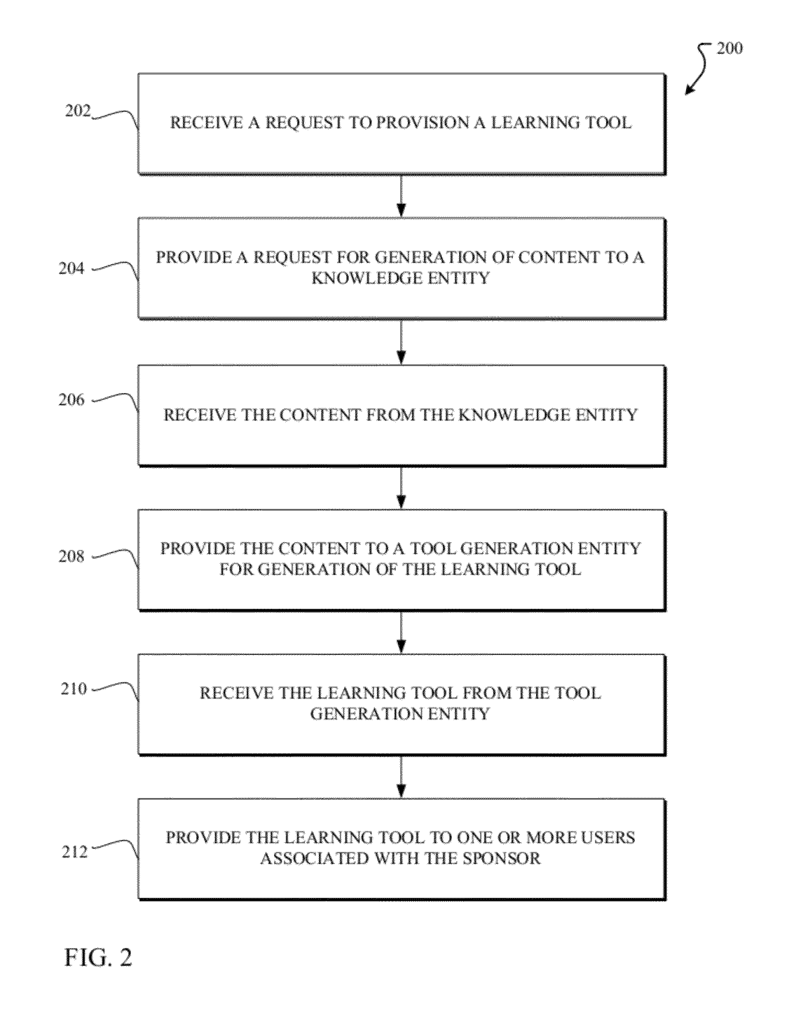

FIG. 2 shows an exemplary process 200 for provisioning an electronic learning tool for one or more users. A request to provision an electronic learning tool is received (202). For example, the sponsor 104 may generate a request for an electronic learning tool that is configured to educate one or more of the users 108 about content in a particular subject area. The sponsor 104 transmits the request to the learning tool administration entity 102, which logs the requirements specified in the request and begins attempting to provision an electronic learning tool that fulfills the logged requirements.

A request for generation of content is communicated to an entity having access to knowledge of one or more subject areas (204). For example, the learning tool administration entity 102 may communicate a request to the knowledge entity 106 that causes the knowledge entity 106 to begin generating content for use in the electronic learning tool requested by the sponsor 104. The request communicated to the knowledge entity 106 by the learning tool administration entity 102 may be in the form of an e-mail, a web form (or a link thereto), a telephone call, a text message (e.g., and SMS message), or a combination thereof. In some examples, the knowledge entity 106 is an individual or institution having (or possessing access to) knowledge that would fulfill the requirements specified in the sponsor's request. Exemplary knowledge entities 106 include educational institutions (e.g., colleges and universities), subject matter experts (e.g., professors, teachers, authors, and other instructors), or other entities that are qualified and able to provide the content specified in the request.

In some examples, the learning tool administration entity 102 may also provide one or more constraints to the knowledge entity 106 that specify the type and/or format of content that should be generated by the knowledge entity 106. The constraints can be provided with (or separate from) the request to generate the content. The learning tool administration entity 102 can provide the constraints in the form of written instructions (e.g., an email that lists the constraints in text form), verbal instructions, or a web form that limits the manner in which the knowledge entity 106 can provide the content. For example, to prevent the knowledge entity 106 from submit content that is too voluminous, the learning tool administration entity 102 may provide a web form for the knowledge entity 106 to complete that limits a number of characters that can be provided as content in a fillable field in the web form.

Content is received from the knowledge entity (206). For example, the learning tool administration entity may receive a message that contains content for use in the generation of the electronic learning tool requested by the sponsor 102. The learning tool administration entity 102 can receive the content in a variety of forms and formats. For example, the knowledge entity can provide the content to the learning tool administration entity 102 in written form (e.g., an email or a completed web form), verbal form, or a combination thereof. The learning tool administration entity 102 can be configured to prompt or complete a review of the content against the requirements specified in the request and/or any constraints provided to the knowledge entity 106 by the learning administration tool 102. In response to reviewing the content, the learning tool administration entity 102 can send additional requests to the knowledge entity 106 or the sponsors 104.

The content is provided to a learning tool generation entity for generation of the learning tool (208). For example, the learning tool generation entity 102 can organize and transmit the content collected from the knowledge entity 106 to the learning tool generation entity 110. In some examples, the learning tool generation entity 110 is an entity that includes machines and/or personnel that are equipped to use the content to generate the electronic learning tool in a format that will be usable by end users of the electronic learning tool (e.g., the users 108). For example, the learning tool generation entity 110 can receive content in the form of text documents and audio files and can generate an electronic learning tool in the form of a slide show that includes text from the documents and audio from the audio files. The learning tool generation entity 110 may apply the received content to one or more templates in order to generate the electronic learning tool. In some examples, the templates provide pre-configured electronic learning tools that only need to be supplemented with content in order to be ready for use by the users 108. Using templates that provide commonly used features can lower the cost and/or resources required to generate the electronic learning tools.

The learning tool generation entity 110 can perform one or more tests on the electronic learning tool to confirm that it is both operational and that it conforms to the specifications provided by the learning tool administration entity 102. For example, if the learning tool administration entity specifies that the electronic learning tool must be usable on machines that use a particular operating system, the learning tool generation entity 110 may test the electronic learning tool on such a platform prior to certifying the electronic learning tool for use.

The learning tool is received from the learning tool generation entity (210). For example, after generating the electronic learning tool using the content created by the knowledge entity 106, the learning tool administration entity 102 receives a completed electronic learning tool from the learning tool generation entity 110. In some examples, the learning tool administration entity 102 includes a database that can be accessed by the learning tool generation entity 110. Upon completing the electronic learning tool, the learning tool generation entity 110 can upload the electronic learning tool to the database.

The learning tool is provided to one or more users associated with the sponsor (212). In some examples, the learning tool administration entity 102 performs checks on the electronic learning tool received from the learning tool generation entity 110 for quality control purposes (e.g., to ensure that the electronic learning tool is operational and that it provides content that fulfills the requirements associated with the sponsor's 102 request). The learning tool administration entity 102 can provide the electronic learning tool to the users 108 using a variety of techniques. For example, the learning tool administration entity can store the electronic learning tool in a location that is accessible to the users 108. In some examples, the electronic learning tool is a software program that users can execute on their local machines, on machines associated with the sponsors 104, or on the learning tool administration entity 102. In some examples, the learning tool administration entity 102 can authenticate the users 108 and/or the sponsors 104 who attempt to access the electronic learning tool. For example, the users 108 could be forced to log into the learning tool administration entity 102 using valid credentials (e.g., a user name and password) in order to access the electronic learning tool. Authentication can be performed even if the electronic learning tool is executed on machines under the control of the users 108.

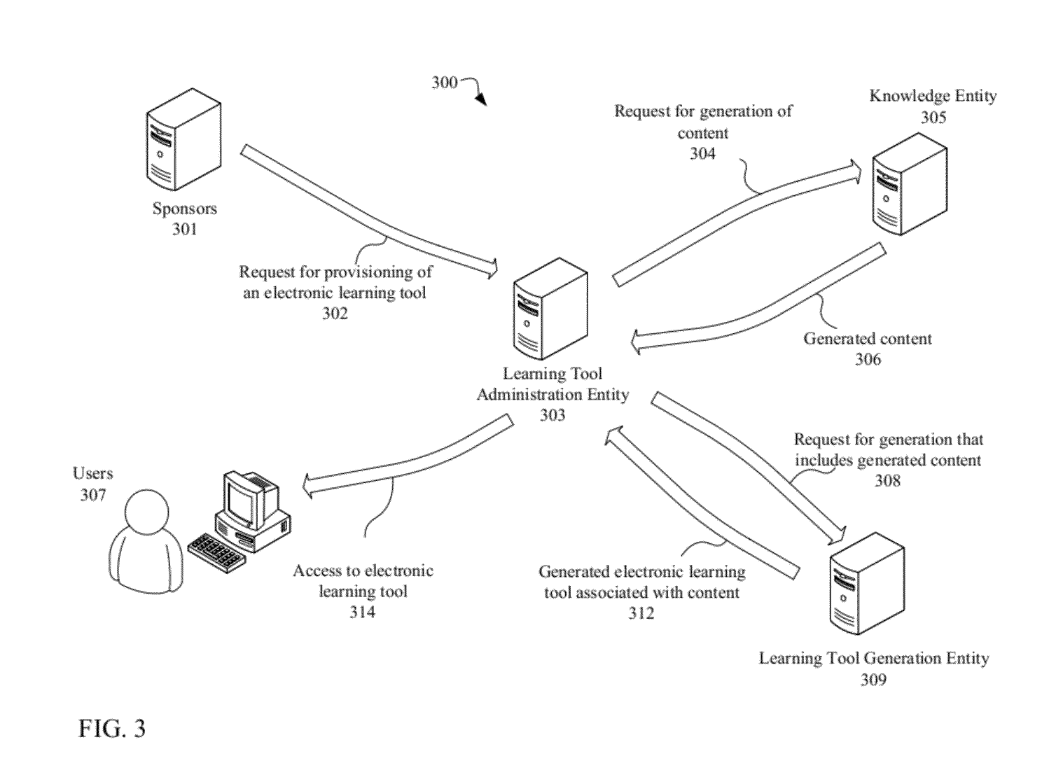

FIG. 3 illustrates an exemplary workflow 300 for the provisioning of a particular variety of electronic learning tool. The specific features discussed with regard to FIG. 3 are exemplary and represent only a subset of the features and specifications that can be implemented to provision an electronic learning tool.

The sponsor 301 generates a request 302 for the provisioning of an electronic learning tool. In this example, the sponsor 301 is a company that employs the users 108, and the request specifies that the electronic learning tool should be software that teaches the users 308 how to use a particular operating system. Accordingly, the sponsor 301 specifies that the subject area of the electronic learning tool is “computer software,” and the content relates to a specific operating system. The request 302 can specify a budget for the creation of the electronic learning tool, a timeframe for the provisioning of the electronic learning tool, the knowledge level of the intended users, and the number of users who will use the electronic learning tool.

After processing the request 302, the learning tool administration entity 303 can transmit a request for the generation of content to the knowledge entity 305, such as a computer science professor at a university. In this case, the request 304 specifies that the knowledge entity 305 should generate content that will teach the users 308 how to use the specified operating system. The learning tool administration entity 302 may also provide one or more web forms to the knowledge entity 305 into which the knowledge entity may enter information that will describe the eventual electronic learning tool (e.g., a presentation name, authors of the content, the estimated difficulty of the material, contact information, prerequisite knowledge, and the like). The request 304 can also include constraints that limit one or more aspects of the content generation. For example, the constraints may limit the knowledge entity 106 to generating content associated with a particular version of the operating system, may provide a specific format for the content (e.g., a spreadsheet), and may provide a budget for the content generation.

In some examples, the content includes one or more of text data and audio visual data. For example, the knowledge entity 305 may provide the generated content 306 in the form of a number of slides that are narrated by an accompanying audio file. The content 306 may also include a transcript of the audio file that is linked to one or more portions of the audio files and/or the text data. For example, portions of the audio file may be configured (e.g., by the learning tool generation entity 309) to play during the presentation of specific slides in the slide show. In this way, the knowledge entity 305 is able to provide a narrated lesson. The content may further include questionnaires that test the users' 307 knowledge of the content or that solicit the users' 307 opinion of the electronic learning tool.

The knowledge entity 305 provides generated content 306 to the learning tool administration entity 303. For example, the knowledge entity 305 may upload the content 306 in a web form hosted by the learning tool administration entity 303. The knowledge entity 305 may further provide instructions for combining different types of content items. For example, the knowledge entity 305 may provide instructions for synchronizing one or more audio files with the presentation of one or more slides.

The learning tool administration entity 303 communicates a request 308 for a generation of an electronic learning tool to the learning tool generation entity 309. The request 308 can include at least a portion of the generated content 306 provided by the knowledge entity 305, and can also include instructions for generating the electronic learning tool (e.g., the instructions described above for combining different types of content). In some examples, the learning tool administration entity 303 stores the content 306 in a database that is accessible (and that can be manipulated) by the learning tool generation entity. The learning tool generation entity 309 may use the generated content 306 in combination with one or more templates (e.g., one or more generic electronic learning tool models) to create a usable electronic learning tool that covers the subject area and the content specified in the request 302. For example, the learning tool generation entity 309 may follow the instructions provided by the learning tool administration entity 303 and the knowledge entity 305 to create a slide show that combines an audio narration with a number of graphical slides such that the audio content is synchronized with the presentation of the slides. The learning tool generation entity 309 may also reference existing (e.g., previously generated) learning tools to determine whether any content or functionality overlap exists, and whether any portions of existing electronic learning tools can be re-used to satisfy the request 302.

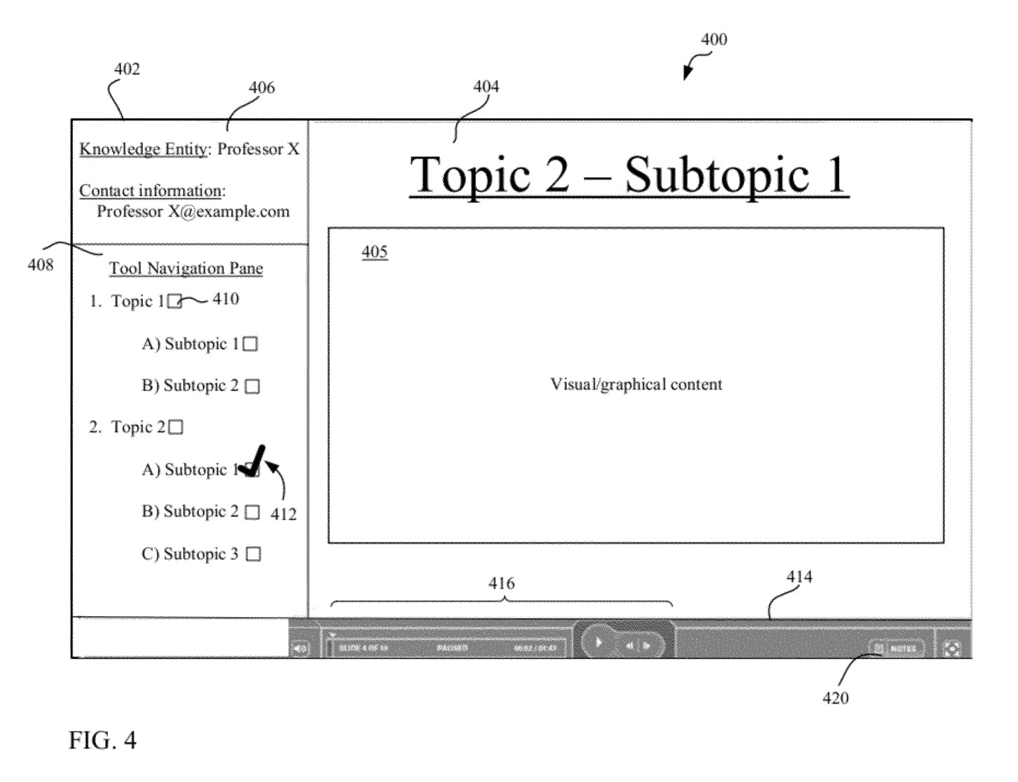

The learning tool generation entity 309 may also enable interactive functionality for use with questionnaires or other interactive components of the electronic learning tool. For example, the learning tool generation entity 309 can use the generated content 306 to generate a questionnaire (e.g., an exam, a quiz, or a survey) that the users 307 can interact with. The learning tool generation entity 309 can configure the electronic learning tool to receive input from the users 307 and provide feedback to the users 307 based on their input. For example, if a user answers a question on a quiz provided in the electronic learning tool, the electronic learning tool may inform the user whether their answer was correct. Similarly, the learning tool generation entity 309 can configure the electronic learning tool to provide feedback to one or more of the sponsor 301, the knowledge entity 305, the learning tool generation entity 309 and the learning tool administration entity 303 based on input from the users 307 (e.g., by passing along the results of a survey to the appropriate entities). The learning tool generation entity 309 can also enable controls (e.g., controls 416 (FIG. 4) that allow the user to control various portions of the electronic learning tool, such as the playback of audio content.

The learning tool generation entity 309 provides a generated electronic learning tool 312 that is associated with the subject area and content specified in the request 302. In some examples, the learning tool generation entity 309 uploads the electronic learning tool to a database on the learning tool administration entity 102.

After receiving the electronic learning tool from the learning tool generation entity 309, the learning tool administration entity provides access 314 to the electronic learning tool 312. While the example of FIG. 3 illustrates that access 314 is provided directly to the users 307, the learning tool administration entity may also provide access to the electronic learning tool 312 via the sponsor 301. Prior to allowing the users 307 to access the electronic learning tool 312, the learning tool administration entity may send out requests for review of the electronic learning tool 312 to one or more of the sponsors 104, the knowledge entity 106, and the learning tool generation entity 110. Access can be provided to the users 307 in the form of insertable media (e.g., a CD or DVD ROM containing software that represents the electronic learning tool 312), or by providing instructions to the users 307 or the sponsors 301 for accessing a remote location that stores and/or is configured to execute the electronic learning tool. For example, the learning tool administration entity may expose an interface (e.g., using a web page) which the users 307 can use to access a repository containing electronic learning tools. The users 307 may then execute the electronic learning tool 312 (e.g., by viewing a slide show that educates the users 307 how to use an operating system) including any interactive content associated with the electronic learning tool 312 (e.g., completing a quiz that relates to the use of the operating system and/or a survey regarding the effectiveness of the electronic learning tool 312).

FIG. 4 is a screenshot 400 of an exemplary electronic learning tool being executed on a user device. The electronic learning tool is a slideshow 402 (e.g., as discussed above with regard to FIG. 3) that is meant to educate users on a variety of topics. The slideshow 402 includes an information pane 406 that identifies the knowledge entity as “Professor X” and further provides contact information for the knowledge entity. The slideshow 408 further provides a tool navigation pane 408 which includes a navigable hierarchy. Users can activate controls (e.g., controls 410, 412) in the navigable hierarchy in order to access specified portions of the slideshow 402. In the example of FIG. 4, a user has activated the control 412 to access a portion of the slideshow 408 associated with Topic 2, Subtopic 1. This portion of the slideshow 402 is presented in a main presentation pane 404 that includes a visual/graphical content pane 405.

The slideshow 408 also includes an audio content portion 414. The audio content portion 414 includes controls 416 for manipulating the playback of audio content associated with the slideshow 402, such as the narration of a slide associated with Topic 2, Subtopic 1. The audio content portion 414 also includes a note control 420 which can be used to access a transcript of the audio content. Accessing the transcript using the note control 420 may display a portion of the transcript associated with the audio content current being played back. That is, the presentation of the audio content and the transcript of the audio content can be synchronized with each other, and can be synchronized with the presentation of a particular slide (or other form of visual content).

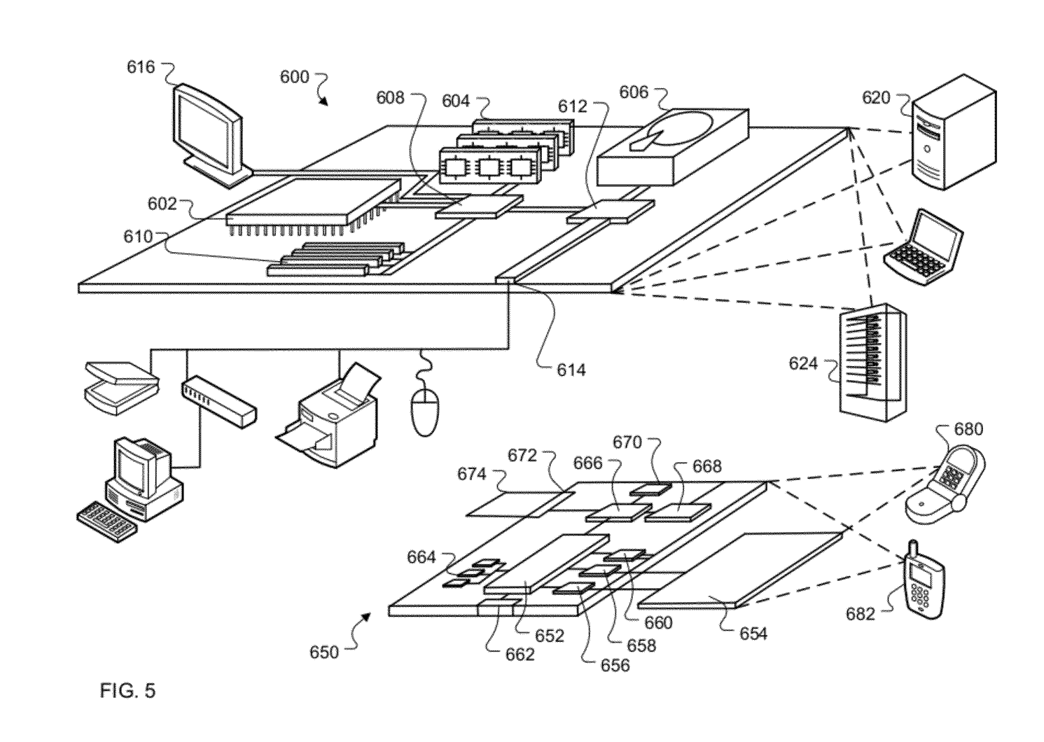

FIG. 5 shows an example of a computing device 600 and a mobile computing device 650 that can be used to implement the techniques described in this disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A method for providing an electronic learning tool configured to teach content associated with one or more subject areas, the method comprising:
receiving, from a sponsor, a request for a provisioning of the electronic learning tool;
communicating, to an entity having access to knowledge of the one or more subject areas, a request for a generation of the content;
receiving the content from the entity;
providing the content to a tool generation entity for generation of the electronic learning tool;
receiving the electronic learning tool from the tool generation entity; and
providing the electronic learning tool to one or more users associated with the sponsor.

2. The method of claim 1, wherein the content comprises both audio and visual content.

3. The method of claim 2, wherein the audio content comprises a voice recording that is associated with the visual content.

4. The method of claim 3, wherein receiving the electronic learning tool from the tool generation entity comprises receiving audio content that is synchronized with a display of one or more portions of the visual content.

5. The method of claim 1, wherein providing the content to the tool generation entity comprises:
storing the content in a database; and
providing the tool generation entity with access to the database.

6. The method of claim 1, further comprising:
in response to receiving the request for a generation of the electronic learning tool from the sponsor:
determining whether one or more pre-existing electronic learning tools satisfy the request.

7. The method of claim 1, wherein the electronic learning tool comprises an electronic course that is configured to be presented on a user device.

8. The method of claim 1, where the electronic learning tool is configured to receive input from the one or more users.

9. The method of claim 8, wherein the electronic learning tool is configured to evaluate the input to assess the one or more users' knowledge of the content.

10. The method of claim 8, wherein the electronic learning tool is configured to evaluate the input to determine the one or more users' opinion of an effectiveness of the electronic learning tool.

11. The method of claim 1, wherein receiving the content from the entity comprises receiving at least a portion of the content as a completed template.

12. The method of claim 1, further comprising providing, to the entity, one or more constraints for generating the content.

13. A computer storage medium encoded with a computer program, the program comprising instructions for providing an electronic learning tool configured to teach content associated with one or more subject areas that, when executed by one or more computers, cause the one or more computers to perform operations comprising:
receiving, from a sponsor, a request for a provisioning of the electronic learning tool;
communicating, to an entity having access to knowledge of the one or more subject areas, a request for a generation of the content;
receiving the content from the entity;
providing the content to a tool generation entity for generation of the electronic learning tool;
receiving the electronic learning tool from the tool generation entity; and
providing the electronic learning tool to one or more users associated with the sponsor.

14. The computer storage medium of claim 1, wherein the content comprises both audio and visual content.

15. The computer storage medium of claim 14, wherein the audio content comprises a voice recording that is associated with the visual content.

16. The computer storage medium of claim 15, wherein receiving the electronic learning tool from the tool generation entity comprises receiving audio content that is synchronized with a display of one or more portions of the visual content.

17. The computer storage medium of claim 13, wherein providing the content to the tool generation entity comprises:
storing the content in a database; and
providing the tool generation entity with access to the database.

18. The computer storage medium of claim 13, further comprising instructions that cause the one or more computers to perform operations comprising:
in response to receiving the request for a generation of the electronic learning tool from the sponsor:
determining whether one or more pre-existing electronic learning tools satisfy the request.

19. The computer storage medium of claim 13, wherein the electronic learning tool comprises an electronic course that is configured to be presented on a user device.

20. The computer storage medium of claim 13, where the electronic learning tool is configured to receive input from the one or more users.

21. The computer storage medium of claim 20, wherein the electronic learning tool is configured to evaluate the input to assess the one or more users' knowledge of the content.

22. The computer storage medium of claim 20, wherein the electronic learning tool is configured to evaluate the input to determine the one or more users' opinion of an effectiveness of the electronic learning tool.

23. The computer storage medium of claim 13, wherein receiving the content from the entity comprises receiving at least a portion of the content as a completed template.

24. The computer storage medium of claim 13, further comprising instructions that cause the one or more computers to perform operations comprising:
providing, to the entity, one or more constraints for generating the content.
